(19) United States
(12) Patent Application Publication
(10) Pub. No.: US 2007/0110498 A1
(43) Pub. Date: May 17, 2007

(54) Writing Instrument And Cosmetic Compact

(76) Inventor: Daniel Walsh, Drakes Branch, VA (US)

Correspondence Address: GLEN E. SCHUMANN;C/O MOSS & BARNETT, 90 SOUTH SEVENTH STREET, 4800 WELLS FARGO CENTER, MINNEAPOLIS, MN, 55402-4129, US

(21) Appl. No.: 11/463,851

(22) Filed: Aug. 10, 2006

Related U.S. Application Data
(60) Provisional application No. 60/707,207, filed on Aug. 10, 2005.

(51) Int. Cl. B43K 27/02; B05C 1/00; B43K 29/00

(52) U.S. Cl. 401/18; 401/195; 401/17

(57) ABSTRACT

A writing instrument and cosmetic compact having a writing cartridge disposed in a housing or barrel adapted to receive a compact designed to hold a cosmetic or similar makeup. The ink cartridge can be filled with an ink that is only visible upon interaction with another medium such as a light source, another chemical, or warmed or heated air.

### PRIORITY

This application claims the benefit of the provisional application having Ser. No. 60/707,207 filed on Aug. 10, 2005, which is hereby incorporated in its entirety by reference.

### BACKGROUND OF THE INVENTION

1. Field of the Invention

The present invention relates to writing instruments and more particularly to a writing instrument that has a cosmetic compartment and mirror.

2. Description of the Prior Art

Cosmetic applicators have been known in the prior art for some time. These applicators tend to be large, bulky and heavy. The size and weight of these applicators is directly related to the need for room for the cosmetic and means of application.

In U.S. Pat. No. 2,057,085, to G. J. Danco, a cosmetic applicator for lipstick is shown comprising an outer protective casing that is adapted to serve as a handle for applying the cosmetic to the user. The disclosed device includes flexible applicator band rotatably disposed on a complicated roller assembly. The user rotates the applicator band passed the cosmetic disposed in an interior of the housing, thereby picking up the cosmetic for application on the user. The disadvantage of the present reference is that it is complicated, difficult and time consuming to use. Additionally, the device is limited to the application of the cosmetic contained in the housing.

There have also been devices developed to remove a cosmetic or make-up from a user. In U.S. Pat. No. 6,148,828, to Bourassa, a device is disclosed comprising a casing having a wiping tip protruding from one of its ends. Similar to the device to Danco above, a slidable ribbon of wiping material is disposed in the casing. The Bourassa device includes a storage compartment (an interior of the casing) for holding unused wiping material until it is advanced over the wiping tip, used and eventually feed into a refuse compartment. A disadvantage of the present device is that it includes a complicated advancement mechanism to advance the wiping material from the storage compartment to the refuse compartment. Additionally, the device is limited to the removal of a cosmetic or make-up material.

What is needed is a device that provides uncomplicated access to and/or application of a cosmetic to a user. What is additionally needed is a device that can be utilized for something other than the storage or application of a cosmetic.

### SUMMARY OF THE INVENTION

The invention is a writing instrument having cosmetic compartment and/or mirror disposed to a housing or barrel that can be griped by a user during use. The housing can contain a writing implement such as a pen cartridge or a make-up applicator that can be used with the cosmetic compartment to apply a cosmetic to a user.

A wipe material can be removably stored in an interior of the housing for selective removal by a user through a slot or slit extending through and along at least a portion of the length of the housing. The wipe material can be saturated with chemical to aid in the removal of the cosmetic. In another embodiment, the wipe material can be impregnated with a scent that would be pleasant to the user. The scent can be a perfume that the user wipes upon themselves at any time of the user's choosing.

A nose cap can be removably coupled to an end of the housing to secure the ink cartridge for writing. The nose is also adapted to retain the wipe material in the interior of the housing. In one example embodiment, the nose cap can have a shape, size, or configuration to allow it to be used as the applicator for the cosmetic contained within the cosmetic compartment.

A nose cap cover can be removably coupled to and telescopically extend over the nose cap to provide a means of protecting the nose cap. The nose cap cover can have an attachment means formed, coupled and the like thereto to permit convenient transportation of the device.

An end cap can be coupled to an end of the housing opposite the nose cap. The end cap is utilized to secure a free end of the ink cartridge in the housing. In the example embodiment having a wiping material, the end cap can be utilized to retain the wiping material in the interior of the housing.

In one example embodiment of the invention, the cosmetic compartment is disposed to the end cap during transportation and/or while the device is being used as a writing instrument. An inner cover can be hingedly coupled proximate to an opening of the cosmetic compartment to define an interior for retaining the cosmetic.

A mirror cap or reflective end cover can be disposed to an end of the cosmetic compartment to allow a user to observe the application of the cosmetic.

An object of the invention is to provide a writing instrument having a cosmetic compartment that is easily manufactured and used.

Another objection of the invention is to provide a cosmetic compartment containing that is visually integrated with the housing of the writing instrument.

The above summary of the invention is not intended to describe each illustrated embodiment or every implementation of the invention. The figures in the detailed description that follow more particularly exemplify these embodiments.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an exploded view of a writing instrument and cosmetic compact according to an example embodiment of the present invention.

FIG. 2A is a perspective view of a nose cap according to an example embodiment of the present invention.

FIG. 2B is a cross section view along line 1-1 of the nose cap of FIG. 2A.

FIG. 2C is an end view of the nose cap of FIG. 2A.

FIG. 2D is a partial perspective view of FIG. 2C.

FIG. 3A is a cross sectional view of a nose cap cover of FIG. 1 showing an interior thereof.

FIG. 3B is an end view of the nose cap cover of FIG. 3A showing an opening extending therethrough.

FIG. 3C is cross section view of the nose cap cover of FIGS. 3A and 3B illustrating a cosmetic applicator assembly in an extended position.

FIG. 3D is a cross section view of the nose cap cover of FIGS. 3A and 313 illustrating a cosmetic applicator assembly in a retracted position.

FIG. 4A is a side view of a coupling member for receiving a tether or the like for hanging the writing instrument and cosmetic compact about a user's neck.

FIG. 4B is a perspective view of the coupling member of FIG. 4A.

FIG. 5A is an exploded perspective view of an end cap assembly comprising an outer end cap and an inner end cap according to an example embodiment of the present invention.

FIG. 5B is a cross section view of the outer end cap of FIG. 5A.

FIG. 5C is an end view of the outer end cap of FIG. 5A.

FIG. 5D is a cross section of the inner end cap of FIG. 5A.

FIG. 5E is an end view of the inner end cap of FIG. 5A.

FIG. 6A is an enlarged view of an end of the outer end cap showing a coupling assembly.

FIG. 6B is a top view of the coupling assembly of FIG. 6A.

FIG. 7A is a perspective view of a reflective member and cosmetic compact according to an example embodiment of the invention.

FIG. 7B is a side view of the cosmetic compact of FIG. 7A.

FIG. 7C is an end view of the cosmetic compact of FIG. 7A.

FIG. 7D is a side view of the reflective member of FIG. 7A.

FIG. 7E is an end view of the reflective member of FIG. 7A.

The preceding description of the drawings is provided for example purposes only and should not be considered limiting. The following detailed description is provided for more detailed examples of the present invention. Other embodiments not disclosed or directly discussed are also considered to be within the scope and spirit of the present invention.

### DESCRIPTION OF THE PREFERRED EMBODIMENT

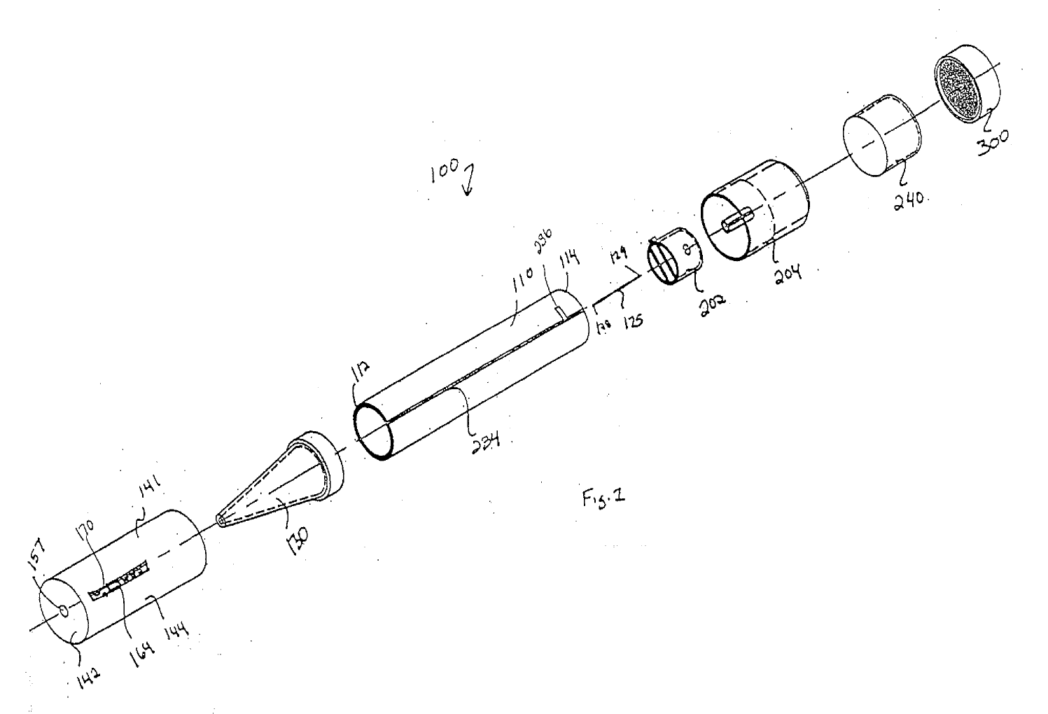

Referring to FIGS. 1-7E, a writing instrument and cosmetic compact is indicated by the number 100. Writing instrument and cosmetic compact 100 includes a housing, barrel, or pen tube 110 having an open first end 112 and an open second end 114 in registration with each other.

Referring to FIG. 1, in a preferred embodiment, housing 110 is manufactured from a polymer such as polypropylene, polyethylene and the like. Housing 110 can be manufactured with any color, design or lettering printed on its outer surface for advertising of a particular trademark, logo, or brand. This is of particular importance if the writing instrument and cosmetic compact 110 is utilized as a marketing tool since vivid colors, designs and lettering typically attract a user's eyes and others toward the writing instrument.

To ensure that housing 110 is comfortable to use it may have a generally cylindrical shape. However, housing 110 may have any cross sectional shape such as, for example triangular, square, oval, and the like. An outer surface of housing 110 may be coated and/or ribbed to increase tactile feel and improve comfort. A compressible sleeve (not shown) can be slid over housing 110 to provide additional comfort for a user.

In one example embodiment, as illustrated in FIG. 1, an ink, marker or similar writing cartridge 125 is removably disposed within housing 110. Writing cartridge 125 has a first writing end 128 that can be disposed proximate open first end 112 of housing 110 and second securing end 129 proximate open second end 114 of housing 110. Writing cartridge 125 can dispense an ink, a cosmetic such as eyeliner, lipstick, or the like. In one embodiment, ink cartridge 125 dispenses an ink having the properties to be initially invisible or undetectable to the naked eye, only to reappear after a duration of time or the application of heat, another chemical, or the like.

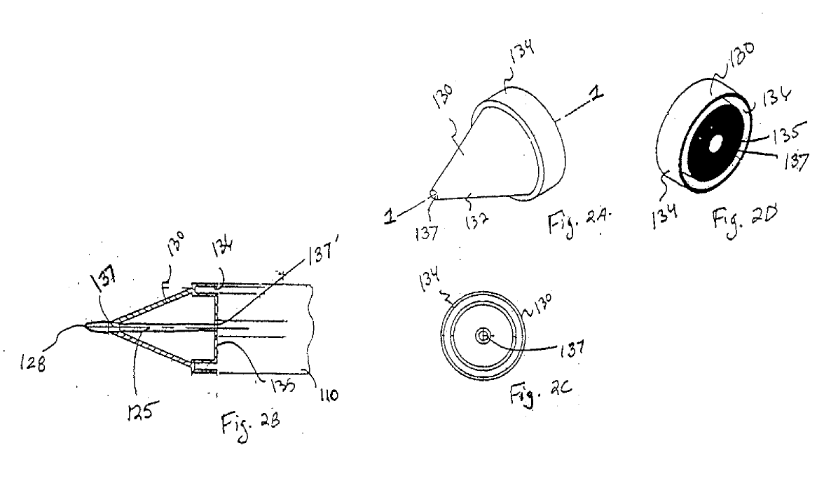

Referring to FIGS. 2A-2D, and initially to FIG. 2A, a nose cap 130 can be removably disposed over open first end 112 of housing 110 to provide support to writing cartridge 125. In one example embodiment, nose cap 130 has a generally conical shape with a generally conical tip portion 132 and a generally annular collar portion 134. Referring to FIG. 2C, the generally annular collar portion 134 has an outer diameter generally greater than an outer diameter of tip portion 132. As particularly illustrated in FIGS. 2B-2D, nose cap 130 can have a lower or bottom wall 135 for supporting ink cartridge 125 when disposed in housing 110. An annular channel 136 extends into annular collar portion 134 and about bottom wall 135 for receiving open first end 112 of housing 110.

In one example embodiment, nose cap 130 can be threadedly coupled to housing 110. In another example embodiment, nose cap 130 can be pressure fitted to housing 110. Other fastening methods and means are also possible and should be considered to be within the spirit and scope of the invention.

Referring to FIG. 2B, when nose cap 130 is disposed on housing 110, first writing end 128 of writing cartridge 125 extends through holes 137 and 137′ extending through tip portion 132 and bottom wall 135 respectively.

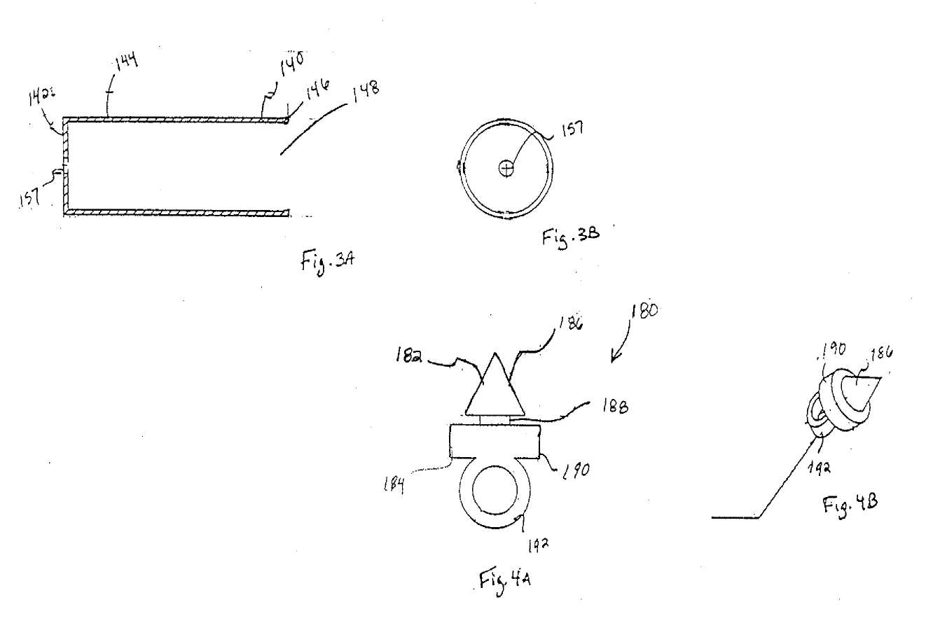

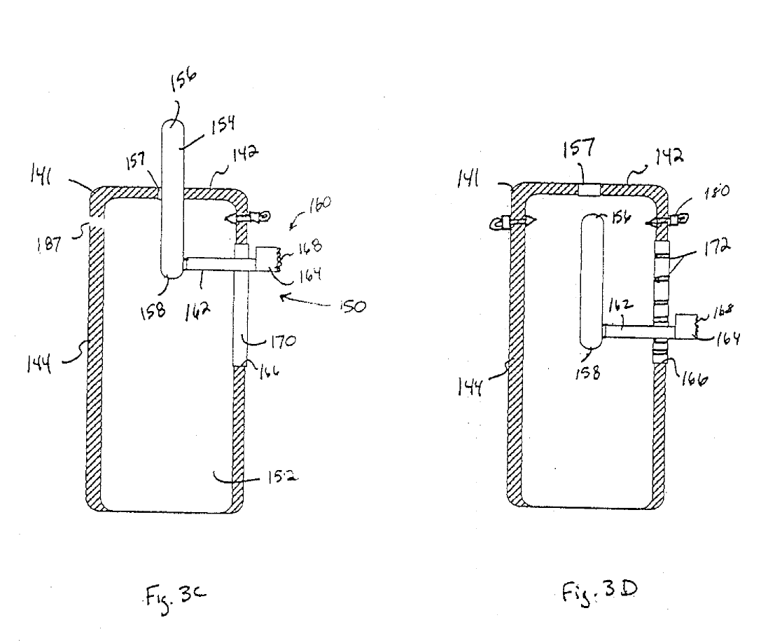

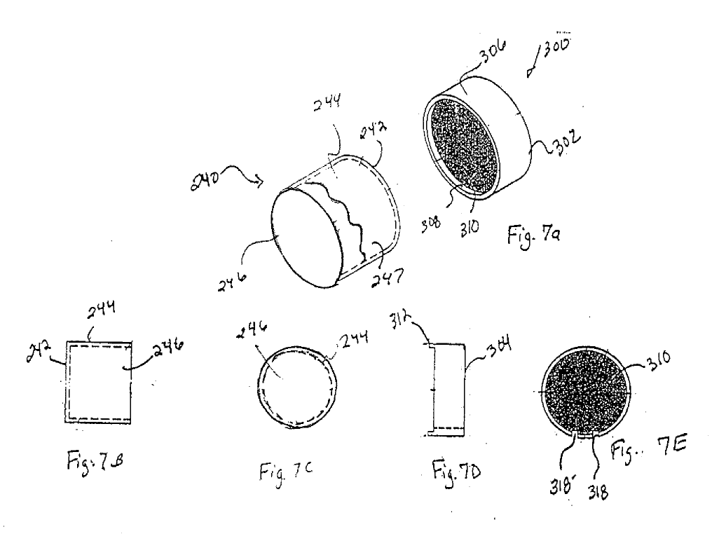

Referring to FIGS. 1 and 3A and 3B, a nose cap cover 141 can be provided to prevent first writing end 128 of writing cartridge 125 from drying out. The nose cap cover 141 has a top or upper wall 142 and a peripheral wall 144 extending away therefrom. Referring to FIGS. 7A-7C, peripheral wall 144 has an edge 146 defining an access opening 148 for receiving nose cap 130. Nose cap cover 141 can comprise any generally rigid material such as plastic, wood, metal or the like.

Referring to FIGS. 3C 3D, nose cap cover 141 can include a cosmetic applicator assembly 150 operatively disposed in an interior 152 thereof for applying the cosmetic on the user. In one example embodiment, the cosmetic applicator assembly 150 comprises a brush, elongate generally absorbable pad, or other like applicator 154 that is operatively disposed in and extendable from an interior of the housing 110. The applicator can have a first end 156 that is extendable through an opening 157 in the upper wall 142 of the nose cap cover 141.

A second end 158 of the applicator 154 can be attached to a slide mechanism 160 that is utilized by a user to move the applicator 154 between an extended position (see FIG. 3C) and a retracted position (see FIG. 3D). The extended position is defined by the first end 156 of the applicator 154 extending through the opening 157 of the nose cap cover 141. The retracted position is defined by the applicator 154 being substantially enclosed in the nose cap cover 141.

In one embodiment, the slide mechanism comprises at one elongate slide 162 having a knob portion 164 extending through an elongate slot or slit 166 in the peripheral wall 144 of the nose cap cover 141. A user can user their thumb or finger to move the knob portion 164 along the slot or slit 166 and concomitantly, vertically move the applicator 154 between the extended and retracted positions. An outer surface of the knob portion 164 can include knobs, ribs, ridges, protrusions and the like 168 to facilitate the grip of the user's thumb or finger on the knob while moving it between the extended and retracted positions.

In one embodiment of the invention, as illustrated in FIG. 1, an edge 170 defining the slot or slit 166 in the peripheral wall 144 of nose cap cover 141 can include spaced apart recesses or protrusions 172 that receive or interact with a portion of slide or knob portion 168 or slide 162 to retain the applicator in a relatively fixed position while being used. Other types of mechanisms are possible to facilitate the at least temporary fixing of the applicator 154 in either the extended or retracted position and should be considered to be within the spirit and scope of the invention.

In another embodiment of the invention, the applicator 154 can be removably disposed to another portion of the housing 110. In this embodiment, the applicator 154 can be removably disposed to the second end 114 of housing 110 or other portion conducive to holding or receiving the applicator 154 in any form.

Referring to FIGS. 4A and 4B, a coupling member 180 such as an eyelet, loop, hook, strap, tether, and similar devices can be coupled to the peripheral wall 144 of nose cap cover 141 to allow a user to more easily carrying the writing instrument and cosmetic compact 100. In an example embodiment, as illustrated in FIGS. 4A and 4B, coupling member 180 comprises an eyelet having plug portion 182 joined to and extending from an anchoring portion 184. Plug portion 182 is adapted for operative engagement to any portion of writing instrument and cosmetic compact 100, but preferably the peripheral wall 144 of nose cap cover 141.

In an example embodiment, plug portion 182 can include a conical section 186 disposed on an end of a shaft section 188 that is centrally disposed on anchor portion 184. Conical section 186 is adapted for operative engagement with at least one hole 187 extending into nose cap cover 141.

Anchor portion 184 can include a base section 190 and an attachment section 192. The shaft section 188 is disposed on an upper surface of base section 190 while the attachment section 192 is disposed on a lower surface of base section 190. In on example embodiment, attachment section 192 comprises a loop that is adapted to receive a tether or similar device. Attachment member 180 can comprise any compressible material such as rubber, plastic and the like.

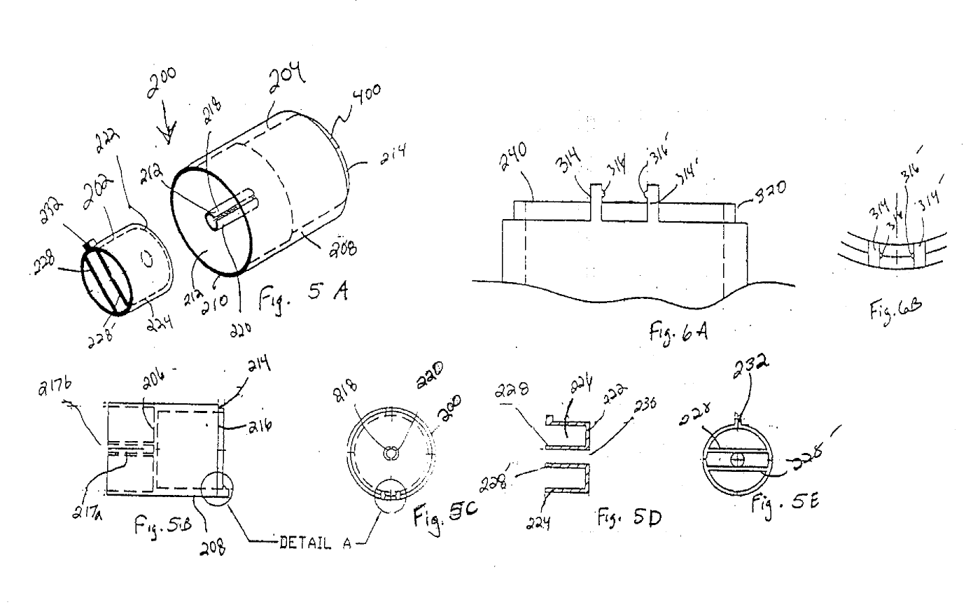

Referring now to FIGS. 1 and 5A-5E, at least one end cap assembly 200 is detachably couplable to the open second end 114 of housing 110 for holding the second end 129 of writing cartridge 125. In one embodiment, end cap assembly 200 comprises an inner end cap 202 and an outer end cap 204 with the outer end cap 204 adapted to receive the inner end cap 202 and a compartment 400 adapted to hold a cosmetic.

Referring to FIGS. 5A and 5B, the outer end cap 204 includes a generally centrally disposed wall 206 having a peripheral wall 208 extending diametrically from opposed surfaces of the wall 206 such that a bottom rim or lip 210 (see FIG. 5B) of the peripheral wall 208 defines an access opening 212 for receiving the inner end cap 202. An upper rim 214 of the peripheral wall 208 defines an access opening 216 for receiving the compartment 400.

Outer end cap 204 includes a post 217a having a bore 217b extending longitudinally therein for receiving and at least temporarily securing cartridge 125. Post 217a is centrally disposed on and extends from the central wall 206. In another example embodiment, as particularly illustrated in FIG. 5C, post 217a is divided along its longitudinal axis defining first 218 and second 220 post portions that extend away from each other when writing cartridge 125 is inserted in bore 217b. In this embodiment, an inner diameter of bore 217b is at least slightly smaller than an outer diameter of writing cartridge 125 to create a friction fit therebetween.

Referring to FIGS. 5A, 5D, and 5E, inner end cap 202 is operatively coupled between housing 110 and outer end cap 204 to secure outer end cap 204 to housing 110. In an example embodiment, as particularly illustrated in FIG. 5D, inner end cap 202 has a top wall 222 and a peripheral wall 224 extending away therefrom forming an interior space 226. A pair of supports 228 and 228′ can be disposed in and extend generally across the interior space 226. Supports 228 and 228′ can comprise plates or panels having a length generally equal to a length of peripheral wall 224.

Top wall 222 of inner end cap 202 has a generally centrally disposed aperture 230 extending therethrough for receiving post 217a. In an example embodiment, post 217a is disposed generally between supports 228 and 228′. Inner end cap 202 can be secured in outer end cap 204 by an adhesive or other mechanical means such as by threaded engagement.

Inner end cap 202 can also include a tab 232 extending away from an outer surface of its peripheral wall 224 for operatively engaging and securing inner end cap 202 and outer end cap 204 to housing 110. In an example embodiment, as illustrated in FIGS. 1, tab 232 can operatively engage a slit 234 and a notch 236 extending transversely therefrom into housing 110. To secure inner end cap 202 to housing 110, tab 232 is inserted and slid within slot 232. Tab 232 becomes aligned with notch 234. Rotation of inner end cap 204 forces tab 232 into notch 234 such that it extends transversely through notch 234 preventing its disengagement from housing 110. Other means of engaging inner end cap 203 to housing 110 are also contemplated by the invention, for example threaded engagement, pressure fitting, and snap fitting.

Referring to FIGS. 6A-7E, and initially to FIGS. 7A-7E, the compartment 240 includes a bottom wall 242 and a peripheral wall 244 extending away therefrom defining an interior 246. A cosmetic 247, such as lip gloss, lipstick, eye shadow, and the like is disposed in the interior 246 of the compact 240. As illustrated in FIG. 7C, compact 240 has a generally circular cross section. However, depending upon the cross sectional shape of housing 110 and outer end cap 204, compact 240 can have any cross sectional shape. In one embodiment, the outer end cap 204 and the compact 240 are manufactured from a clear material such that the cosmetic 247 is visible from outside of writing instrument and cosmetic compact 100.

Referring back to FIG. 5A, compact 540 has a size and shape adapted for fitting into recess opening 216 of outer end cap 204. In one embodiment, compact 240 is pressure fitted in the access opening 216 to temporarily secure compact 240 within outer end cap 204 until a user pulls on an end of compact 240 thereby removing it from the outer end cap 204. In another embodiment of the invention, an outer surface of the peripheral wall 244 of compact 240 may be threadedly coupled to an inner surface of the peripheral wall 208 of the outer end cap 204. Other methods and means of coupling, securing, fixing, attaching the compact 240 to the outer end cap 204 are also possible and should be considered to be within the spirit and scope of the invention.

Referring to FIGS. 7A, 7D and 7E, a mirror or similar reflective member 300 can be coupled to outer end cap 204 to permit a user to observe themselves while applying the cosmetic. Reflective member 300 can comprise a housing 302 having a top wall 304 and a peripheral wall 306 defining an interior 308 thereof. A reflective mirror or similar surface 310 can be disposed in the interior 308. In an alternate embodiment, an inner surface of top wall 304 can be polished to create a reflective surface, thereby eliminating the need for a separate mirror.

As illustrated in FIG. 7D, a lip 312 can extend beyond the mirror. Lip 312 can be used to operatively couple reflective member 300 to the outer end cap 204. As illustrated in FIG. 6A a pair of prongs 314 and 314′ can extend from lip 214 of outer end cap 204. Each of the prongs 314 and 314′ includes a protrusion 316 and 316′ respectively that can engage a portion of reflectively member 300. As illustrated in FIG. 7E, housing 302 of reflective member 300 can include a pair of slots 318 and 318′ for receiving prongs 314 and 314′ respectively. An inner surface of slots 318 and 318′ can include depressions for receiving protrusions 316 and 316′. In this particular embodiment, reflective member 300 is hingedly coupled to outer end cap 204 between an open position and a closed position. Reflective member 300 can also be threadedly coupled, pressure fitted, or snapped on outer end cap 204. Other forms of engagement are also contemplated and should be considered to be within the spirit and scope of the invention.

As illustrated in FIG. 6A, the compact 240 can extend beyond the lip 214 of outer end cap 204. The reflective member 300 can include a space defined by its lip 312 such that when the reflective member 300 is in the closed position the compact 240 can extend into at least a portion of the interior 308 of the reflective member 300. When the reflective member 300 is closed its lip 312 surrounds the compact 240.

After purchase, a user lifts the reflective member 300 exposing the compact 240. The user can then pull, rotate, pivot and the like to remove the compact 240 from the outer end cap 204. Once the compact 240 has been removed, the user can press, slide, or otherwise move knob portion 164 such that the first end 156 of the applicator 154 extends through the opening 157 of the nose cap cover 141.

The user then places the tip or first end 156 of the applicator 154 into the cosmetic 247 to pick up some cosmetic for placing on their lips, eyelids or other bodily features. A user can then retract the applicator 154 back into the nose cap cover 141 for storage.

A user can also remove the nose cap cover 141 to expose the cartridge 125 to right a message, note, and the like on a piece of paper. However, upon writing a message on the substrate, a user notices that no ink has apparently been disposed on the substrate. In example embodiments, the ink can reappear after a predefined period of time; if the user blows their warm breath on the ink soaked substrate; or if the user applies another chemical such as lemon juice and the like.

In another embodiment, the ink may comprise a chemical or material, such as luminol. Once a light is placed on the ink soaked substrate it will illuminate the written message.

In yet another embodiment, a user can write a message in reverse with the invisible ink contained in the ink cartridge 125. Another user can then use reflective member 300 and the light chemical, breath and the like to read the reversed message.

In another embodiment, wipes impregnated or soaked in a cleaning solution can be rolled up and placed in the interior of housing 110 such that when a user wants to remove the cosmetic they can pull the wipe through slit 234 of the housing 110. In this example embodiment, the roll of wipes can include a plurality of wipes connected linearly by spaced transversally extending perforations.

Numerous modifications are also contemplated in the present invention. For example, all parts of writing instrument and cosmetic compact 100 can be manufactured from a single material or they may comprise any combination of various materials. Advertising, logos, designs and other indicia can be imprinted or imparted on any component of writing instrument and cosmetic compact 100 including, but not limited to, housing 110, nose cap 130, cover 160, nose cap cover 140, and/or end cap 170.

The present invention may be embodied in these and other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed is:

1. An instrument and cosmetic compact comprising:
a housing;
a cosmetic compartment disposed to the housing, the cosmetic compartment having a cosmetic disposed therein;
an implement being disposed in the housing; and
a wipe being removably disposed in the housing and extendable through a slit formed therein.

2. The instrument and cosmetic compact of claim 1, wherein the cosmetic compartment is removably attached to an end of the housing, whereby cosmetic compacts containing different cosmetics are interchangeable with the housing.

3. The instrument and cosmetic compact of claim 1, wherein the implement is a writing cartridge.

4. The instrument and cosmetic compact of claim 1, wherein the implement is an applicator for inserting into the cosmetic compartment.

5. The instrument and cosmetic compact of claim 3, further comprising a nose cap cover detachable over the writing cartridge, the nose cap cover having an applicator retractably disposed therein for inserting into the cosmetic compartment.

6. The instrument and cosmetic compact of claim 3, wherein the applicator has a first end extendable through an opening in the cover and a second end attached to a slide mechanism operatively disposed in the cover, the second end extends through a slot in the nose cap cover, whereby a user can operatively extend and retract the applicator.

7. The instrument and cosmetic compact of claim 1, wherein the wipe contains a chemical to aid in the removal of the cosmetic.

8. The instrument and cosmetic compact of claim 1, wherein the wipe is impregnated with a scent that the user can apply to themselves.

9. The instrument and cosmetic compact of claim 1, further comprising a mirror attached to the cosmetic compact to permit a user to observe themselves while applying the cosmetic.

10. An instrument and cosmetic compact comprising:
an elongate housing having a first end, a second end and an interior, the housing having an elongate slit providing access to the interior;
an end cap being disposed to the second end of the housing;
a cosmetic compartment containing a cosmetic, the cosmetic compartment being removably attachable to the end cap;
an implement being disposed proximate the first end of the housing; and
a wipe being disposed in the interior of the housing, the wipe being removable from the housing through a slit extending along at least a portion of the housing.

11. The instrument and cosmetic compact of claim 10, wherein the end cap has a recess in which the cosmetic compact is removably disposed.

12. The instrument and cosmetic compact of claim 10, wherein the cosmetic compact is threadedly coupled to the end cap.

13. The instrument and cosmetic compact of claim 10, wherein the cosmetic compact includes a lid hingedly coupled thereto, an inner surface of the lid having a reflective surface, whereby a user can observe themselves while applying the cosmetic.

14. The instrument and cosmetic compact of claim 10, wherein the wipe contains a chemical to aid in the removal of the cosmetic.

15. The instrument and cosmetic compact of claim 10, wherein the wipe is impregnated with a scent for application upon the user.

16. The instrument and cosmetic compact of claim 10, wherein the implement is a writing cartridge.

17. The instrument and cosmetic compact of claim 10, wherein the implement is an applicator for inserting into the cosmetic compartment.

18. The instrument and cosmetic compact of claim 16, further comprising a cover detachable over the writing cartridge, the cover having an applicator retractably disposed therein for inserting into the cosmetic compartment.

19. The instrument and cosmetic compact of claim 18, wherein the applicator has a first end extendable through an opening and a second end attached to a slide mechanism that extends through a slot in the cover, whereby a user can extend and retract the applicator.

20. A method of carrying a cosmetic compact comprising the steps of:
providing a housing having a first end, a second end and an interior;
removably attaching to the second end of the housing a cosmetic compact containing a cosmetic;
disposing in the first end of the housing a writing cartridge for writing;
providing in the interior of the housing a plurality of individual wipes that can be used to apply or remove the cosmetic; and
removably covering the writing cartridge with a nose cap cover having a retractable applicator disposed therein for applying the cosmetic.
